(19) United States
(12) Patent Application Publication
(10) Pub. No.: US 2013/0117533 A1
(43) Pub. Date: May 9, 2013

(54) COPROCESSOR HAVING TASK SEQUENCE CONTROL

(71) Applicant: Jan Hayek, Muenchen (DE)

(72) Inventor: Jan Hayek, Muenchen (DE)

(21) Appl. No.: 13/642,952

(22) PCT Filed: Apr. 6, 2011
(86) PCT No.: PCT/EP2011/055305

§ 371 Date: Jan. 4, 2013

(30) Foreign Application Priority Data
Apr. 27, 2010 (DE) 10 2010 028 227.8

(51) Int. Cl. G06F 15/76

(52) U.S. Cl. CPC G06F 15/76
USPC 712/30

(57) ABSTRACT

A coprocessor has: a processing unit for processing tasks in a data-processing system subject to at least one master processor; at least one storage module having memory areas, assignable in each case to the tasks, for storing data assigned to the tasks; and a buffer area for buffering instructions assigned to the tasks, the instructions including processing instructions, and upon retrieval of the processing instructions from the buffer area, the data stored in the storage module being processed on the basis of the processing instructions.

### BACKGROUND OF THE INVENTION

1. Field of the Invention

The present invention relates to a coprocessor having a processing unit for processing tasks in a data-processing system subject to at least one master processor, a corresponding data-processing system, as well as a method for processing tasks in a corresponding data-processing system, i.e., using a corresponding coprocessor.

2. Description of the Related Art

The present invention is useable particularly in what are termed Systems on a Chip (SoCs)or one-chip systems, in which at least one master processor (CPU) for central control, memories for storing data and programs, as well as various circuits (coprocessors) adapted to individual tasks are provided. However, in principle, the present invention may be employed in all systems in which it is necessary to control or influence processing of data and/or tasks allocated by at least one CPU.

The term “SoC” embraces systems in which all, or at least a great portion of system functions are combined on a single piece of silicon (chip) (monolithic integration). SoC systems are usually used in embedded systems. SoCs represent a further development of systems in which originally, one microprocessor or microcontroller IC and a number of further ICs were surface-mounted on a board. Digital, analog and mixed-signal functional units are frequently integrated in SoCs. In particular, cost reduction and miniaturization may thereby be attained.

The internal interconnection in an SoC system is accomplished with the aid of one or more buses, in doing which, hierarchical or segmented bus systems may be used in more complex systems. As mentioned, in corresponding systems, specific specialized coprocessors are provided in each case for specific tasks, and are set up subject to a control by at least one CPU to process tasks assigned to them. Within the scope of this patent application, coprocessor is understood to be a unit of this kind, which, however, is not specially defined with regard to its physical realization.

If several different tasks require access to a single coprocessor, that is, to the power of a single coprocessor, a CPU of a data-processing system should be in the position to see to it that the tasks do not influence each other negatively or collide with one another. In this connection, potentials for conflict exist especially in systems having a plurality of CPUs (what are called multicore systems), in which several CPUs use one or more coprocessors jointly to process certain tasks. One task must thus either terminate its function before the next task can have access to the coprocessor, or the context of the task must be stored and restored later. For simpler operations, this usually does not represent a problem; however, more complex tasks may delay the system in a way that is intolerable or even bring it to a standstill.

There is thus the need for easily implementable possibilities to process tasks, especially several tasks to be processed simultaneously or directly one after another, in a coprocessor of a data-processing system subject to a master processor, by which collision of tasks and/or a disadvantageous delay of the processing may be avoided.

### BRIEF SUMMARY OF THE INVENTION

To that end, proposed according to the present invention are a coprocessor having a processing unit for the processing of tasks in a data-processing system subject to at least one master processor, a corresponding data-processing system, as well as a method for processing tasks in a corresponding data-processing system, i.e., using such a coprocessor.

The invention makes use of the fact that the flow of individual programs or tasks is not disturbed if the coprocessor has a buffer area (e.g., a FIFO) in order—essentially irrespective of its state of utilization or operating state—to be able to accept instructions (commands) pertaining to the coprocessor and coming from one or more master processors. In this context, the buffered commands contain instructions which concern the processing of data with the aid of the coprocessor or its processing unit itself (processing instructions) and may further include instructions which relate to the status of the processing (status instructions), in order to signal it to a CPU, for example.

As customary in corresponding buffer areas, such instructions are stored or buffered sequentially, whereby the instructions stored first are able to be called up (i.e., executed) as first again (FIFO principle). The provision of such a buffer area makes it possible to assign tasks to a coprocessor, regardless of an execution time needed to process a command in a processing unit. On the other hand, traditionally, a coprocessor is not able to accept a second command during the execution time of a first command; thus, during this time, it is blocked for other tasks, and accepts them only when the first task has been executed. Because of this, in the case of the coprocessors of the related art, in some instances, individual tasks only get a chance very belatedly or not at all.

Furthermore, a coprocessor according to the invention has at least one storage module in which, in each case, specific memory areas may be assigned to individual tasks of the coprocessor by a CPU, for example. If 32 registers are available in a memory area, for instance, 8 may be assigned exclusively to a task A, 2 to a task B and 4 to a task C, etc. The corresponding data is stored in the respective memory areas according to addresses assigned to the data, and the result data is able to be called up according to addresses.

An advantage of a corresponding embodiment is that very simply, a FIFO module of a suitable size, for example, may be selected for buffering the instructions and adapted to the respective tasks (e.g., their number or processing time) in order to match the performance capacity of a corresponding system. On the other hand, it is not necessary to alter any algorithms or programs. Mutual influencing (interference or collision) between tasks is thereby avoided.

As mentioned, each task may be assigned the status instructions already named before, which likewise are buffered in the buffer area. For example, the status instructions are created for the setting of bits in a specific flow register, a finite state machine (FSM) being used to set these bits. The finite state machine is set up for this purpose in addition to its original task, the interpretation of the instructions buffered in the buffer area and retrieved accordingly, as well as the control of the execution of these instructions. Like in the memory area explained above, specific areas assignable (e.g., by the CPU) to the respective tasks are provided in the flow register, as well. Owing to the status instruction, for instance, a completed execution of a task may be indicated by setting a corresponding bit in the flow register. The CPU is then able to read out the flow register, is thereby informed of the processing of a command, and may retrieve the result of the processing from the coprocessor accordingly.

For this purpose, expediently, a status instruction is downstream of the processing instruction or a chain of processing instructions, and is only executed when the processing instruction or chain of processing instructions is completely processed. The bits in the flow register are able to be reset by, that is, for each task individually, e.g., by a CPU, by writing into this register (Clear on Write “1”). Alternatively, a status instruction may also write a specific value into an area of the flow register, which overwrites a value possibly present there before. In this case, no separate reset needs to be carried out.

In this manner, tasks which are complex and/or extensive in terms of their turnaround time are able to be set for a coprocessor simultaneously, without a complex task switching or data sequence control by the CPU being necessary during operation. The tasks or their respective processing instructions are processed one after another by a processing unit of the coprocessor; the successful processing may be signaled in each instance by an indicator. Resources of an SoC are thereby conserved, resulting in savings in energy consumption and the costs thus incurred.

With respect to the advantages and features of the method according to the present invention for data processing, reference is made specifically to the features explained previously.

Further advantages and refinements of the present invention are yielded from the description and the accompanying drawing.

It shall be understood that the aforementioned features and the features yet to be explained below may be used not only in the combination indicated in each instance, but also in other combinations or by themselves, without departing from the scope of the present invention.

The invention is represented schematically in the drawing in light of exemplary embodiments, and is described in detail below with reference to the drawing.

### BRIEF DESCRIPTION OF THE DRAWINGS

FIG. 1 shows a data-processing system according to an especially preferred specific embodiment of the invention in schematic representation.

FIG. 2 shows the operation sequence of a method according to an especially preferred specific embodiment of the invention in schematic representation.

### DETAILED DESCRIPTION OF THE INVENTION

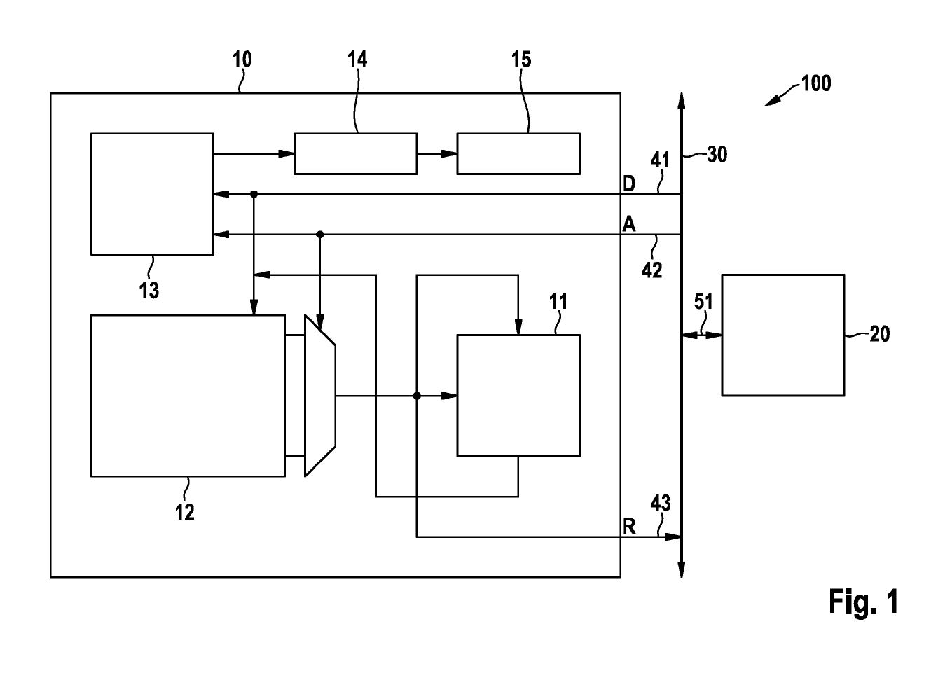

FIG. 1 shows a data-processing system 100 according to an especially preferred specific embodiment of the present invention. Data-processing system 100 has a coprocessor 10 which is explained below, a master processor 20 in the form of a microcontroller, for example, as well as data-communication means 30, e.g., a system bus. Data D as well as addresses A assigned to the data are able to be made available to the coprocessor via system bus 30, that is, via data and address lines 41, 42, 43 allocated to it. Data from the coprocessor, e.g., result R of a calculation carried out in the coprocessor, may be retrieved via data line 43. On its part, the master processor is connected to bus 30 via a data line 51.

For the sake of clarity, data and address lines 41, 42, 43, 51 are shown exclusively in FIG. 1. In addition, as one skilled in the art knows, also provided in corresponding data-processing systems 100 are control lines, for example, via which, as explained in greater detail below, a finite state machine 14 is able to control a flow register 15, a storage module 12 and a data-processing unit 11, for instance.

Coprocessor 10 has a storage module 12, e.g., a RAM memory unit or a corresponding register memory. The use of “real” registers instead of RAM does not influence the functionality of such a coprocessor, but may create a greater space requirement. Storage module 12 has memory areas, assignable to allocated tasks, for storing data D—assigned to the tasks and addressed via addresses A—which was provided via data line 41. As mentioned, the memory areas may be assigned to the tasks by master processor 20, for example.

Coprocessor 10 also has a buffer area 13. Instructions assigned to the tasks are buffered in buffer area 13; as mentioned, the instructions include processing instructions (thus, instructions for processing the data with the aid of at least one data-processing unit 11 likewise provided), and possibly status instructions (thus, instructions for the definition or indication of a status of the processing of the data).

Buffer area 13 is realized here as a FIFO, however, may also take the form of a sequentially operating RAM memory, for example. In the latter case, a corresponding master processor must be set up to write instructions in targeted manner into specific memory areas.

The status instructions, possibly stored in buffer area 13, may be used to set bits in a flow register 15 in order to signal a processing status. To that end, a finite state machine 14 is provided which additionally, as explained, interprets instructions buffered in buffer area 13 and retrieved appropriately, and via control lines, for example, controls the execution of these instructions. Each task may be assigned certain bits in the flow register, which may be set or reset by the status instructions according to the processing of the tasks. In other words, a status of a processing of instructions is signaled in accordance with status instructions in flow register 15 of coprocessor 10, to which the CPU has access. After the processing has been signaled, the CPU may then in each case retrieve the result from the coprocessor.

Coprocessor 10 further has a processing unit for processing tasks. For example, processing unit 11 may take the form of a cryptography module if coprocessor 10 is designed, e.g., as an AES coprocessor of a hardware security module. For example, such a cryptosystem coprocessor may be used within the framework of a control device. In a coprocessor 10 of this kind in the form of an AES coprocessor, instructions are processed, for instance, as follows:

Coprocessor 10 stores task-specific data D, e.g., cryptography keys and/or data to be encrypted, according to an addressing A in storage module 12 in a memory area assigned there to the task. Instructions assigned to the task are buffered in buffer area 13. Upon retrieval of the instructions from buffer area 13, data D is processed by processing unit 11 on the basis of processing instructions contained in the instructions. In this context, data is called up from storage module 12, that is, from a corresponding memory area, encrypted using processing unit 11, e.g., with AES, and the results are stored in storage module 12.

If, according to the sequence instructions, a status instruction is located in buffer area 13, it is retrieved after the processing. The status instruction sets a corresponding bit in a flow register 15, which indicates to the CPU that the processing of the task is complete. Thus, results R are able to be retrieved from the corresponding memory area.

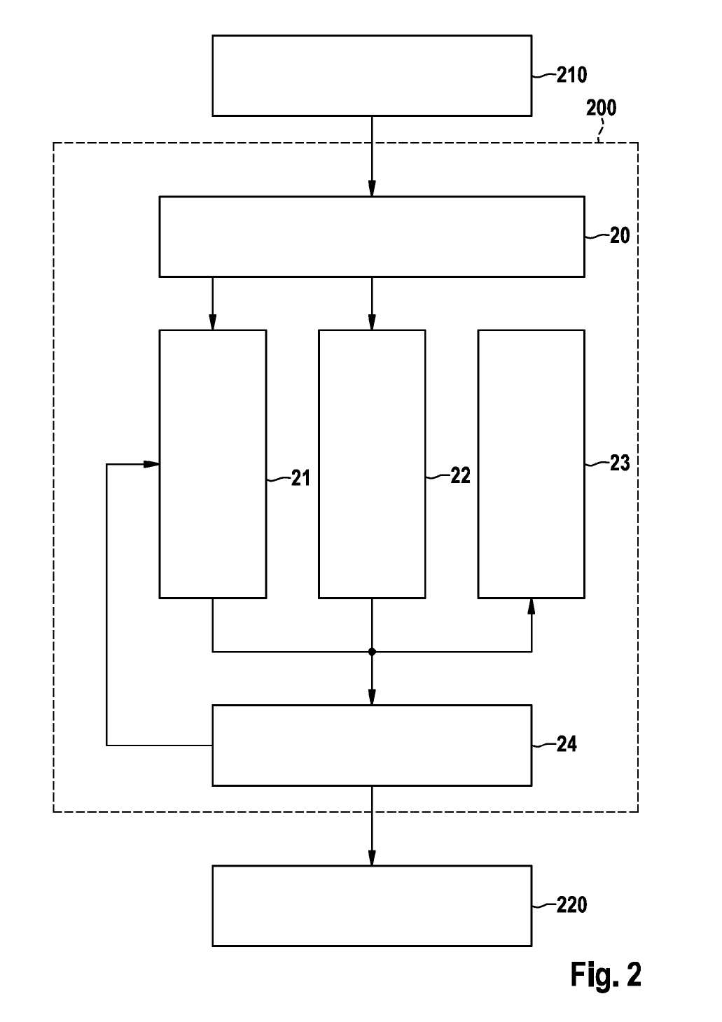

The method according to one especially preferred specific embodiment of the present invention is illustrated schematically in FIG. 2. The method steps proceeding in coprocessor 10 of the invention are denoted by 200. In method steps 210 and 220, tasks are allocated to the coprocessor, and are retrieved in the form of results R from the coprocessor.

Method steps 200 proceeding in the coprocessor include a step 20, in which data D is stored 21 in a storage module. The data is held available in the storage module up until its retrieval. At the same time, instructions are buffered 22 in a buffer area of the coprocessor. Status instructions assigned to the data may also be buffered in the buffer area, and using a finite state machine, for example, may be used to indicate 23 a status of a processing in a flow register. It may be provided for a notification (e.g., an interrupt) to be triggered when the buffer area is (nearly) filled, in order to prevent overfilling. Alternatively or additionally, it may be provided for a notification (e.g., an interrupt) to be triggered when the buffer area is (nearly) emptied, in order to indicate the possibility for a filling.

In response to a retrieval of processing instructions from the buffer area, data stored 21 in the memory area is retrieved and processed 24. If, for example, a status instruction is retrieved from the buffer area directly after a processing instruction, a status (a successful processing) of the processing instruction previously processed may therefore be indicated 23.

The results of processing 24 are stored 21 in a memory area and may be retrieved accordingly (e.g., on the basis of a complete processing indicated in the flow register).

1-10. (canceled)

11. A coprocessor in a data-processing system having at least one master processor, the coprocessor comprising:
a processing unit for processing tasks;
at least one storage module having memory areas allocated to the tasks and storing data assigned to the tasks; and
a buffer area for buffering instructions assigned to the tasks, wherein the instructions include processing instructions, and upon retrieval of the processing instructions from the buffer area, the data stored in the storage module are processed on the basis of the processing instructions.

12. The coprocessor as recited in claim 11, further comprising:
a flow register, wherein the instructions further include status instructions, and a status of the processing of the data on the basis of the processing instructions is indicated in the flow register.

13. The coprocessor as recited in claim 12, wherein at least one of: (i) the memory area is in the form of at least one of RAM memory and a register; and (ii) the buffer area is in the form of at least one of a FIFO and a sequentially operating RAM memory.

14. The coprocessor as recited in claim 12, further comprising:
a finite state machine which indicates in the flow register the status of the processing.

15. The coprocessor as recited in claim 14, wherein the processing unit is configured to process tasks in accordance with the finite state machine.

16. The coprocessor as recited in claim 14, wherein the processing unit is configured to process encryption tasks.

17. A data-processing system, comprising:
at least one master processor;
a coprocessor including:
a processing unit for processing tasks;
at least one storage module having memory areas allocated to the tasks and storing data assigned to the tasks; and
a buffer area for buffering instructions assigned to the tasks, wherein the instructions include processing instructions, and upon retrieval of the processing instructions from the buffer area, the data stored in the storage module are processed on the basis of the processing instructions; and
a data-communication unit for transmitting data and instructions between the master processor and the coprocessor.

18. The data-processing system as recited in claim 17, wherein the data-processing system is in the form of a multicore system having at least two master processors.

19. The data-processing system as recited in claim 18, wherein the data-processing system is in the form of a hardware security module, and wherein the coprocessor is an AES processor.

20. A method for processing tasks in a data-processing system having at least one master processor, a coprocessor and a data-communication unit, wherein the coprocessor includes a processing unit for processing tasks, at least one storage module having memory areas allocated to the tasks, and a buffer area, wherein the instructions include processing instructions, the method comprising:
transmitting data via the data-communication unit to the coprocessor;
storing, by the coprocessor, the data in the memory areas of the storage module allocated to the tasks;
buffering, by the coprocessor, processing instructions assigned to the tasks in the buffer area;
retrieving the processing instructions from the buffer area; and
processing, by the coprocessor, the data stored in the memory areas of the storage module on the basis of the processing instructions.
